(19) United States
(12) Patent Application Publication
(10) Pub. No.: US 2023/0391994 A1
(43) Pub. Date: Dec. 7, 2023

(54) RUBBER COMPOSITION BASED ON A HIGHLY SATURATED DIENE ELASTOMER

(71) Applicant: COMPAGNIE GENERALE DES ETABLISSEMENTS MICHELIN, Clermont-Ferrand (FR)

(72) Inventors: GUILLAUME PIBRE, Clermont-Ferrand (FR); THOMAS FERRAND, Clermont-Ferrand (FR)

(21) Appl. No.: 18/024,553

(22) PCT Filed: Sep. 3, 2021
(86) PCT No.: PCT/FR2021/051515

§ 371 Date: Mar. 3, 2023

(30) Foreign Application Priority Data
Sep. 4, 2020 (FR) 2009004

(51) Int. Cl. C08L 23/08; C08K 5/3445; C08K 3/36; C08K 5/14; C08F 222/10; C08K 5/548; B60C 1/00

(52) U.S. Cl. CPC C08L 23/083; C08K 5/3445; C08K 3/36; B60C 1/0016; C08F 222/102; C08K 5/548; C08K 5/14

(57) ABSTRACT

A rubber composition is based on at least: an elastomer matrix comprising more than 50 phr of a copolymer containing ethylene units and 1,3-diene units, the ethylene units in the copolymer representing more than 50 mol % of the monomer units of the copolymer; a specific 1,3-dipolar compound; a filler comprising predominantly silica and a crosslinking system comprising at least one radical polymerization initiator, and a co-crosslinking agent selected from the group consisting of (meth)acrylate compounds, maleimide compounds, allyl compounds, vinyl compounds and mixtures thereof.

The field of the present invention is that of diene rubber compositions which are reinforced by an inorganic filler such as silica and which can be used in particular in the manufacture of tyres for vehicles. It relates more particularly to the treads of pneumatic or non-pneumatic tyres having an improved compromise of rolling resistance/wear.

Since fuel economy and the need to protect the environment have become a priority, it is desirable to produce mixtures having good wear resistance properties while having a hysteresis which is as low as possible in order to be able to process them in the form of rubber compositions which can be used in the manufacture of various semi-finished products involved in the composition of pneumatic or non-pneumatic tyres, for example treads.

To reduce the rolling resistance, it is known to use diene rubber compositions which are reinforced by an inorganic filler, such as silica. Diene rubber compositions reinforced with an inorganic filler generally comprise a silane as coupling agent, such as a polysulfide or a blocked mercaptosilane, which is a silane bearing a protected thiol function. The silane makes it possible to create interactions between the diene elastomer and the inorganic filler and to promote the dispersion of the inorganic filler in the rubber composition.

Furthermore, in order to obtain the optimum reinforcing properties conferred by a filler in a rubber composition, and thus high wear resistance, it is known to be generally advisable for this filler to be present in the elastomer matrix in a final form that is both as finely divided as possible and as homogeneously distributed as possible. In point of fact, such conditions can only be achieved in so far as this filler exhibits a very good ability, on the one hand, to be incorporated in the matrix during the mixing with the elastomer and to deagglomerate and, on the other hand, to disperse homogeneously in this matrix. As is well known, carbon black has such abilities. On the other hand, this is generally not the case with inorganic fillers, in particular silicas. This is because, for reciprocal affinity reasons, these inorganic filler particles tend to clump together in the elastomer matrix. These interactions have the negative consequence of limiting the dispersion of the filler and thus the reinforcing properties to a level substantially lower than that which it would be theoretically possible to achieve if all the (inorganic filler/elastomer) bonds capable of being created during the compounding operation were actually obtained. These interactions moreover tend to increase the consistency in the uncured state of the rubber compositions and thus to make their processability more difficult than in the presence of carbon black.

It therefore remains difficult to develop compositions, filled with silica as filler, which have both excellent rolling resistance and good wear resistance.

It has been possible to improve this performance compromise by virtue of the use, in tyre treads, of novel rubber compositions reinforced with inorganic fillers, in particular specific silicas of the highly dispersible type, which are capable of rivalling, from the reinforcing perspective, a conventional tyre-grade carbon black, while offering these compositions a lower hysteresis, which is synonymous with a lower rolling resistance for the tyres comprising them. Treads filled with such highly dispersible silicas (denoted “HD” or “HDS” for “highly dispersible” or “highly dispersible silica”), which can be used in low rolling resistance tyres sometimes termed “green tyres” in reference to the energy saving afforded to the user (“green tyre concept”), have been widely described. Reference will be made in particular to patent applications EP 501 227, EP 692 492, EP 692 493, EP 735 088, EP 767 206, EP 786 493, EP 881 252, WO 99/02590, WO 99/02601, WO 99/02602 , WO 99/06480, WO 00/05300, WO 000/05301. These prior art documents teach the use of HD silicas having a BET specific surface area of between 100 and 250 m²/g. In practice, one HD silica with a high specific surface area listed in the field of “green tyres” is in particular the Zeosil 1165 MP silica (BET surface area equal to around 160 m²/g) sold by Solvay. The use of this Zeosil 1165 MP silica makes it possible to obtain a good compromises in terms of tyre performance, in particular satisfactory wear resistance and rolling resistance.

However, there is still a need to further improve the performance compromise between the wear resistance and the rolling resistance.

Continuing its research, the applicant has unexpectedly discovered that the combined use of a highly saturated diene elastomer, of a specific 1,3-dipolar compound and of a specific radical crosslinking system akes it possible to further improve the abovementioned performance compromise, in compositions filled with silica.

Thus, one subject of the invention is a rubber composition based on at least:
an elastomer matrix comprising more than 50 phr of a copolymer containing ethylene units and 1,3-diene units, the ethylene units in the copolymer representing more than 50 mol % of the monomer units of the copolymer,
a 1,3-dipolar compound corresponding to the formula (I):

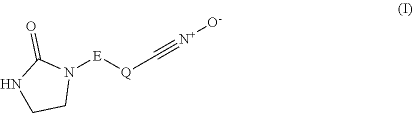

in which:

Q represents an arenediyl ring optionally substituted by one or more identical or different, preferably saturated, linear or branched aliphatic hydrocarbon chains, which are optionally substituted or interrupted by one or more heteroatoms,

E represents a divalent hydrocarbon group optionally comprising one or more heteroatoms,
a filler comprising predominantly silica, and
a crosslinking system comprising at least one radical polymerization initiator, and a co-crosslinking agent selected from the group consisting of (meth)acrylate compounds, maleimide compounds, allyl compounds, vinyl compounds and mixtures.

Another subject of the present invention is a rubber article comprising a composition according to the invention, in particular a tread of a pneumatic or non-pneumatic tyre.

### I—DEFINITIONS

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

For the purposes of the present invention, the expression “part by weight per hundred parts by weight of elastomer” (or phr) should be understood as meaning the part by mass per hundred parts by mass of elastomer.

In the present document, unless expressly indicated otherwise, all the percentages (%) indicated are percentages (%) by weight.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also, and preferentially, denoted.

When reference is made to a “predominant” compound, this is understood to mean, for the purposes of the present invention, that this compound is predominant among the compounds of the same type in the composition, that is to say that it is that which represents the greatest amount by mass among the compounds of the same type. Thus, for example, a predominant elastomer is the elastomer representing the greatest mass relative to the total mass of the elastomers in the composition. In the same way, a “predominant” filler is that representing the greatest weight among the fillers of the composition. By way of example, in a system comprising just one elastomer, the latter is predominant for the purposes of the present invention and, in a system comprising two elastomers, the predominant elastomer represents more than half of the weight of the elastomers. By contrast, a “minor” compound is a compound which does not represent the greatest fraction by mass among the compounds of the same type. Preferably, the term “predominant” is understood to mean present at more than 50%, preferably more than 60%, 70%, 80%, 90%, and more preferentially the “predominant” compound represents 100%.

In the present application, the expression “all of the monomer units of the copolymer” or “the total amount of the monomer units of the copolymer” means all the constituent repeating units of the copolymer which result from the insertion of the monomers into the elastomer chain by polymerization. Unless otherwise indicated, the contents of a monomer unit or repeating unit in the copolymer containing ethylene units and 1,3-diene units are given in molar percentage calculated on the basis of all of the monomer units of the copolymer.

The carbon-comprising compounds mentioned in the description can be of fossil or biobased origin. In the latter case, they may be partially or completely derived from biomass or may be obtained from renewable starting materials derived from biomass. Polymers, plasticizers, fillers, and the like, are concerned in particular.

All the values for glass transition temperature “Tg” described in the present document are measured in a known manner by DSC (Differential Scanning calorimetry) according to Standard ASTM D3418 (1999).

### II—DESCRIPTION OF THE INVENTION

### II-1 Elastomer Matrix

The composition of the tyre according to the invention has the essential feature of comprising an elastomer matrix comprising more than 50 phr of a copolymer containing ethylene units and 1,3-diene units, the ethylene units in the copolymer representing more than 50 mol % of the monomer units of the copolymer.

In the present document, the “copolymer containing ethylene units and 1,3-diene units, the ethylene units in the copolymer representing more than 50 mol % of the monomer units of the copolymer” may be denoted with “copolymer” or with “copolymer containing ethylene units and 1,3-diene units” for the sake of simplicity of wording.

The term “elastomer matrix” is intended to mean all the elastomers of the composition.

The expression “copolymer containing ethylene units and 1,3-diene units” is understood to mean any copolymer comprising, within its structure, at least ethylene units and 1,3-diene units. The copolymer can thus comprise monomer units other than ethylene units and 1,3-diene units. For example, the copolymer can also comprise alpha-olefin units, in particular alpha-olefin units having from 3 to 18 carbon atoms, advantageously having from 3 to 6 carbon atoms. For example, the alpha-olefin units can be selected from the group consisting of propylene, butene, pentene, hexene or mixtures thereof

In a known manner, the expression “ethylene unit” refers to the —(CH₂—CH₂)— unit resulting from the insertion of ethylene into the elastomer chain.

In a known manner, the expression “1,3-diene unit” refers to the units resulting from the insertion of 1,3-diene via a 1,4 addition, a 1,2 addition or a 3,4 addition in the case of isoprene. The 1,3-diene units are those, for example, of a 1,3-diene or of a mixture of 1,3-dienes, the 1,3-diene(s) having from 4 to 12 carbon atoms, such as very particularly 1,3-butadiene and isoprene. Preferably, the 1,3-diene is 1,3-butadiene.

Advantageously, the ethylene units in the copolymer represent between 50 mol % and 95 mol %, preferably between 55 mol % and 90 mol % of the monomer units of the copolymer.

Advantageously, the copolymer containing ethylene units and 1,3-diene units is a copolymer of ethylene and of 1,3-diene, that is to say that the copolymer does not contain any units other than ethylene and 1,3-diene.

When the copolymer is a copolymer of ethylene and of a 1,3-diene, said copolymer advantageously contains units of formula (II) and/or (III). The presence of a saturated 6-membered cyclic unit, 1,2-cyclohexanediyl, of formula (II) as a monomer unit in the copolymer can result from a series of very particular insertions of ethylene and of 1,3-butadiene in the polymer chain during its growth.

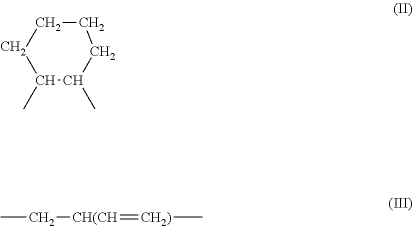

For example, the copolymer of ethylene and of a 1,3-diene can be devoid of units of formula (II). In this case, it preferably contains units of formula (III).

When the copolymer of ethylene and of a 1,3-diene comprises units of formula (II) or units of formula (III) or else units of formula (II) and units of formula (III), the molar percentages of the units of formula (II) and of the units of formula (III) in the copolymer, respectively o and p, preferably satisfy the following equation (eq. 1), more preferentially satisfy the equation (eq. 2), o and p being calculated on the basis of all the monomer units of the copolymer.

0<o+p≤25 (eq. 1)

0<o+p<20 (eq. 2)

According to the invention, the copolymer, preferably the copolymer of ethylene and of a 1,3-diene (preferably of 1,3-butadiene), is a random copolymer.

Advantageously, the number-average mass (Mn) of the copolymer, preferably of the copolymer of ethylene and of a 1,3-diene (preferably of 1,3-butadiene), is within a range extending from 100 000 to 300 000 g/mol, preferably from 150 000 to 250 000 g/mol. The Mn of the copolymer is determined in a known manner, by size exclusion chromatography (SEC) as described below:

The SEC (Size Exclusion Chromatography) technique makes it possible to separate macromolecules in solution according to their size through columns filled with a porous gel. The macromolecules are separated according to their hydrodynamic volume, the bulkiest being eluted first. While it is not an absolute method, SEC gives a picture of the molar mass distribution of a polymer. The various number-average molar masses (Mn) and weight-average molar masses (Mw) can be determined from commercial standards and the polydispersity index (PI=Mw/Mn) can be calculated via a “Moore” calibration.

The polymer sample does not undergo any particular treatment before analysis. The latter is simply dissolved in the elution solvent at a concentration of approximately 1 g·l⁻¹. The solution is then filtered through a filter with a porosity of 0.45 μm before injection. The apparatus used is a Waters Acquity or Waters Alliance chromatographic line. The elution solvent is tetrahydrofuran with 250 ppm of BHT (butylated hydroxytoluene) antioxidant, the flow rate is 1 ml·min−1 , the temperature of the columns is 35° C. and the analysis time is 40 min. The columns used are a set of three Agilent columns having the trade name InfinityLab PolyPore. The volume of the solution of the sample injected is 100 μl. The detector is an Acquity or Waters 2410 differential refractometer and the software for processing the chromatographic data is the Waters Empower system. The calculated average molar masses are relative to a calibration curve produced with polystyrene standards.

The copolymer can be obtained according to various synthesis methods known to those skilled in the art, notably as a function of the targeted microstructure of the copolymer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in documents EP 1 092 731, WO 2004035639, WO 2007054223 and WO 2007054224 in the name of the applicant. The copolymer, including the case when it is random, may also be prepared via a process using a catalytic system of preformed type such as those described in documents WO 2017093654 A1, WO 2018020122 A1 and WO 2018020123 A1.

The copolymer may consist of a mixture of copolymers containing ethylene units and diene units which differ from each other by virtue of their microstructures and/or their macrostructures.

Advantageously, the content of the copolymer containing ethylene units and 1,3-diene units in the composition is within a range extending from 60 to 100 phr, preferably from 80 to 100 phr.

The elastomer matrix may advantageously solely comprise, as elastomer, the copolymer containing ethylene units and 1,3-diene units.

Alternatively, the elastomer matrix may also comprise a diene elastomer other than the copolymer containing ethylene units and 1,3-diene units (also referred to herein as “the other elastomer”). The other elastomer, when it is present, is a minority, that is to say that it represents less than 50%, 40%, 30%, 20% or even less than 10% by weight of the elastomer matrix. For example, the content of the other elastomer in the composition can be within a range extending from 0 to 40 phr, preferably from 0 to 20 phr.

The other elastomer of the elastomer matrix of the tyre according to the invention is preferentially selected from the group of highly unsaturated diene elastomers such as polybutadienes (abbreviated to “BRs”), synthetic polyisoprenes (IRs), natural rubber (NR), butadiene copolymers, isoprene copolymers and mixtures of these elastomers. “Highly unsaturated diene elastomer” is generally understood to mean a diene elastomer resulting at least in part from conjugated diene monomers having a content of units of diene origin (conjugated dienes) which is greater than 50% (mol %).

### II-2 1,3-Dipolar Compound

The rubber composition in accordance with the invention comprises a 1,3-dipolar compound. The term “1,3-dipolar compound” is understood according to the definition given by the IUPAC.

The 1,3-dipolar compound corresponds to the formula (I):

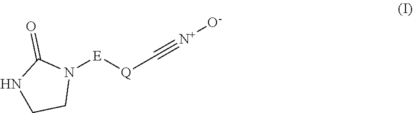

in which:
Q represents an arenediyl ring optionally substituted by one or more identical or different, preferably saturated, linear or branched aliphatic hydrocarbon chains, which are optionally substituted or interrupted by one or more heteroatoms,
E represents a divalent hydrocarbon group optionally comprising one or more heteroatoms.

For the purposes of the present invention, an “arenediyl ring” is understood to mean a monocyclic or polycyclic aromatic hydrocarbon group derived from an arene in which two hydrogen atoms have been removed. An arenediyl ring is thus a divalent group.

For the purposes of the present invention, a “monocyclic or polycyclic aromatic hydrocarbon group” is understood to mean one or more aromatic rings, the backbone of which consists of carbon atoms. In other words, there are no heteroatoms in the backbone of the ring. The arenediyl ring may be monocyclic, i.e. made up of a single ring, or polycyclic, i.e. made up of a plurality of fused aromatic hydrocarbon rings; such fused rings then have at least two successive carbon atoms in common. These rings may be ortho-fused or ortho- and peri-fused.

Preferably, the arenediyl ring comprises from 6 to 14 carbon atoms.

The arenediyl ring may be unsubstituted, partially substituted or fully substituted. An arenediyl ring is partially substituted when one or two or more hydrogen atoms (but not all the atoms) are replaced by one or two or more, preferably saturated, linear or branched aliphatic hydrocarbon chains, which are optionally substituted by one or more heteroatoms. Said chains are also called substituents. If all the hydrogen atoms are replaced with said chains, then the arenediyl ring is fully substituted. The substituents of the arenediyl ring may be identical to or different from each other.

Preferably, when the arenediyl ring is substituted by one or more identical or different, preferably saturated, linear or branched aliphatic hydrocarbon chains, which are optionally substituted or interrupted by one or more heteroatoms, this or these chains can be inert with regard to the N-substituted imidazolidinone function and the nitrile oxide.

For the purposes of the present invention, a “hydrocarbon chain which is inert with regard to the N-substituted imidazolidinone function and the nitrile oxide” is understood to mean a hydrocarbon chain which reacts neither with said N-substituted imidazolidinone function nor with said nitrile oxide. Thus, said hydrocarbon chain which is inert with regard to said N-substituted imidazolidinone function and to said nitrile oxide is preferably an aliphatic hydrocarbon chain which does not have alkenyl or alkynyl functions capable of reacting with said function or said group, that is to say is a saturated, linear or branched aliphatic hydrocarbon chain which is optionally substituted or interrupted by one or more heteroatoms and which preferentially comprises from 1 to 24 carbon atoms.

Preferably, the group Q is a C₆-C₁₄ arenediyl ring optionally substituted by one or more identical or different, preferably saturated, linear or branched aliphatic hydrocarbon chains, which are optionally substituted or interrupted by one or more heteroatoms. More preferentially, the group Q is a C₆-C₁₄ arenediyl ring optionally substituted by one or more identical or different, saturated, linear or branched C₁-C₂₄ hydrocarbon chains, which are optionally substituted or interrupted by one or more nitrogen, sulfur or oxygen heteroatoms. More preferentially still, the group Q is a C₆-C₁₄ arenediyl ring optionally substituted by one or more identical or different substituents selected from the group consisting of a C₁-C₁₂ (more preferentially C₁-C₆, more preferentially still C₁-C₄) alkyl, an OR′ group, an —NHR′ group and an —SR′ group, where R′ is a C₁-C₁₂, more preferentially C₁-C₆, more preferentially still C₁-C₄, alkyl group.

Preferably, the compound of formula (I) is chosen from the compounds of formulae (Ia) and (Ib):

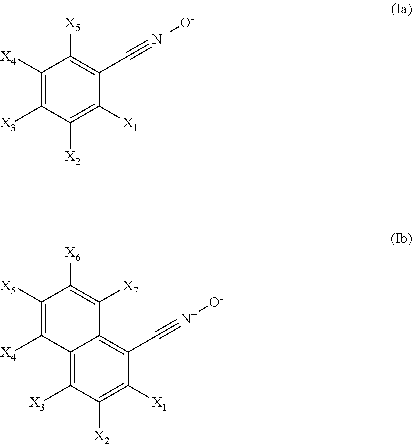

in which:
four groups of formula (Ia) chosen from X₁ to X₅ and six groups of formula (Id) chosen from X₁ to X₇, which may be identical or different, represent a hydrogen atom, a halogen atom or a, preferably saturated, linear or branched aliphatic hydrocarbon chain optionally substituted or interrupted by one or more heteroatoms,
a group chosen from X₁ to X₅ of formula (Ia) and a group chosen from X₁ to X₇ of formula (Ib) denote a covalent bond enabling attachment to the group E of the group of formula (IV) below:

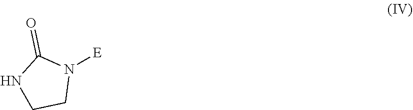

Preferably, in the compounds of formula (Ia) and (Ib), the four groups of the formula (Ia) chosen from X₁ to X₅ other than that denoting a covalent bond enabling attachment to the group E of the group of formula (IV) and the six groups of the formula (Ib) chosen from X₁ to X₇ other than that denoting a covalent bond enabling attachment to the group E of the group of formula (IV), which may be identical or different, represent a hydrogen atom or a saturated, linear or branched C₁-C₂₄ aliphatic hydrocarbon chain optionally substituted or interrupted by one or more heteroatoms.

More preferentially still, in the compounds of formula (Ia) and (Ib), the four groups of the formula (Ia) chosen from X₁ to X₅ other than that denoting a covalent bond enabling attachment to the group E of the group of formula (IV) and the six groups of the formula (Ib) chosen from X₁ to X₇ other than that denoting a covalent bond enabling attachment to the group E of the group of formula (IV), which may be identical or different, are selected from the group formed by a hydrogen atom, a C₁-C₁₂ (more preferentially C₁-C₆, more preferentially still C₁-C₄) alkyl, an —OR′ group, an —NHR′ group and an —SR′ group, where R′ is a C₁-C₁₂, more preferentially C₁-C₆, more preferentially still C₁-C₄, alkyl.

Advantageously, in the formula (Ia), X₂ represents a covalent bond enabling attachment to the group E of the group of formula (IV) defined above and X₁, X₃, X₄ and X₅, which may be identical or different, represent a hydrogen atom or a, preferably saturated, linear or branched C₁-C₂₄ aliphatic hydrocarbon chain optionally substituted or interrupted by one or more heteroatoms. More preferentially, X₂ represents a covalent bond enabling attachment to the group E of the group of formula (IV) defined above and X₁, X₃, X₄ and X₅, which may be identical or different, are selected from the group consisting of a hydrogen atom, a C₁-C₁₂ (more preferentially C₁-C₆, more preferentially still C₁-C₄) alkyl, an —OR′ group, an —NHR′ group and an —SR′ group, where R′ is a C₁-C₁₂, more preferentially C₁-C₆, more preferentially still C₁-C₄, alkyl.

More preferentially still in this embodiment, X₂ represents a covalent bond enabling attachment to the group E of the group of formula (IV) defined above, X₄ represents a hydrogen atom and X₁, X₃ and X₅ represent a, preferably saturated, linear or branched C₁-C₂₄ aliphatic hydrocarbon chain optionally substituted or interrupted by one or more heteroatoms. More preferentially still, X₂ represents a covalent bond enabling attachment to the group E of the group of formula (IV) defined above, X₄ represents a hydrogen atom and X₁, X₃ and X₅,which are identical or different, are selected from the group consisting of a C₁-C₁₂ (more preferentially C₁-C₆, more preferentially still C₁-C₄) alkyl, an —OR'40 group, an —NHR′ group and an —SR′ group, where R′ is a C₁-C₁₂, more preferentially C₁-C₆, more preferentially still C₁-C₄, alkyl.

Advantageously, in the formula (Ib), X₁ represents a covalent bond enabling attachment to the group E of the group of formula (IV) defined above and X₂ to X₇, which may be identical or different, represent a hydrogen atom or a, preferably saturated, linear or branched C₁-C₂₄ aliphatic hydrocarbon chain optionally substituted or interrupted by one or more heteroatoms. More preferentially, X₁ represents a covalent bond enabling attachment to the group E of the group of formula (IV) defined above and X₂ to X₇, which may be identical or different, are selected from the group consisting of a hydrogen atom, a C₁-C₁₂ (more preferentially C₁-C₆, more preferentially still C₁-C₄) alkyl, an —OR′ group, an —NHR′ group and an —SR′ group, where R′ is a C₁-C₁₂, more preferentially C₁-C₆, more preferentially still C₁-C₄, alkyl. More preferentially still in this embodiment, X₁ represents a covalent bond enabling attachment to the group E of the group of formula (IV) defined above and X₂ to X₇, which are identical, represent a hydrogen atom.

In the compounds of formulae (I), (Ia) and (Ib), the group E is a divalent hydrocarbon group which can optionally contain one or more heteroatoms. For the purposes of the present invention, a “divalent hydrocarbon group” is understood to mean a spacer group (or a bonding group) forming a bridge between the group Q and the N-substituted imidazolidinone group, this spacer group being a saturated or unsaturated, preferably saturated, linear or branched C₁-C₂₄ hydrocarbon chain which can optionally contain one or more heteroatoms such as for example N, O and S. Said hydrocarbon chain can optionally be substituted, provided that the substituents do not react with the nitrile oxide and the N-substituted imidazolidinone group as defined above.

Preferentially, in the compounds of formulae (I), (Ia) and (Ib), the group E is a, preferably saturated, linear or branched C₁-C₂₄, more preferentially C₁-C₁₀, more preferentially still C₁-C₆, hydrocarbon chain optionally interrupted by one or more nitrogen, sulfur or oxygen atoms.

Preferably, in the compounds of formulae (I), (Ia) and (Ib), the group E is selected from the group consisting of —R—, —NH—R—, —O—R— and —S—R—, where R is a linear or branched C₁-C₂₄, preferably C₁-C₁₀, more preferentially C₁-C₆, alkylene.

More preferentially still, in the compounds of formulae (I), (Ia) and (Ib), the group E is selected from the group consisting of —R— and —OR—, where R is a linear or branched C₁-C₂₄, preferably C₁-C₁₀, more preferentially C₁-C₆, alkylene.

More preferentially still, in the compounds of formulae (I), (Ia) and (Ib), the group E is selected from —CH₂—, —CH₂—CH₂—, —CH₂—CH₂—CH₂—, —CH₂—CH₂—CH₂—CH₂—, —O—CH₂—, —O—CH₂—CH₂—, —O—CH₂—CH₂—CH₂— and —O—CH₂—CH₂—CH₂—CH₂—.

Advantageously, the 1,3-dipolar compound is chosen from the compounds of formulae (V) to (X) below and the mesomeric forms thereof:

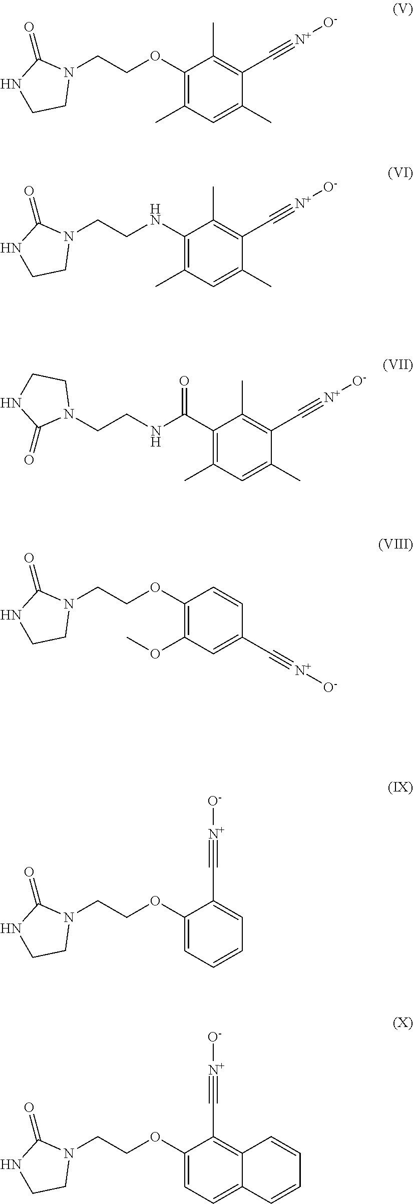 [SMILES: Cc1cc(C)c(OCCN2CCNC2=O)c(C)c1C#[N+][O-] ; Cc1cc(C)c(NCCN2CCNC2=O)c(C)c1C#[N+][O-] ; Cc1cc(C)c(C(=O)NCCN2CCNC2=O)c(C)c1C#[N+][O-] ; COc1cc(C#[N+][O-])ccc1OCCN1CCNC1=O ; O=C1NCCN1CCOc1ccccc1C#[N+][O-] ; O=C1NCCN1CCOc1ccc2ccccc2c1C#[N+][O-]]

Advantageously, the 1,3-dipolar compound is chosen from the compounds of formulae (V), (IX) and (X) and the mesomeric forms thereof:

The amount of 1,3-dipolar compound introduced into the rubber composition is expressed as molar equivalent of imidazole ring. For example, if the 1,3-dipolar compound contains just one imidazole ring of formula (II) as defined above, one mole of imidazole ring corresponds to one mole of 1,3-dipolar compound. If the 1,3-dipolar compound contains two imidazole rings of formula (II) as defined above, two moles of imidazole ring correspond to one mole of 1,3-dipolar compound. In the latter case, the use of the 1,3-dipolar compound according to one molar equivalent of imidazole ring corresponds to a half-mole of 1,3-dipolar compound.

According to the invention, the amount of 1,3-dipolar compound in the composition can be between 0 and 50, preferably between 0.01 and 15, molar equivalents per 100 moles of monomer units constituting the copolymer. For example, it may be between 4 and 15 molar equivalents, for example between 5 and 15 molar equivalents. However, preferentially, the amount of 1,3-dipolar compound in the composition is preferentially between 0 and 3 molar equivalents, more preferentially between 0 and 2 molar equivalents, more preferentially still between 0 and 1 molar equivalent, indeed even more preferentially still between 0 and 0.7 molar equivalents, of imidazole ring per 100 moles of monomer units constituting the copolymer. These preferred ranges make it possible to more finely optimize the compromise between the stiffness in the cured state and the hysteresis of the rubber composition according to its application, in particular in a tyre. More preferably, the amount of 1,3-dipolar compound in the composition is preferentially between 0.1 and 3 molar equivalents, more preferentially between 0.1 and 2 molar equivalents, more preferentially still between 0.1 and 1 molar equivalents, indeed even more preferentially still between 0.1 and 0.7 molar equivalents, of imidazole ring per 100 moles of monomer units constituting the copolymer.

The compounds of formula (I), in particular those of formulae (Ia), (Ib) and (V) to (X), can be obtained from a synthesis process comprising the following successive steps:

(b1) the reaction of a compound of formula (XIII) below:

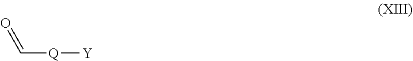

in which Q is as defined above and Y represents a nucleophilic group, with a compound of formula (XIV) below:

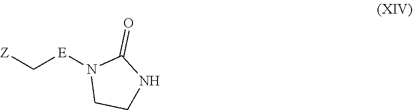

in which E is as defined above and Z represents a nucleofugal group; in the presence of at least one polar solvent S1, of at least one base, at a temperature T1 ranging from 70° C. to 150° C., to form a compound of formula (XV) below:

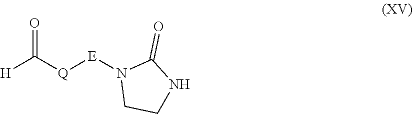

(b2) the reaction of said compound of formula (XV) with an aqueous hydroxylamine solution at a temperature T2 ranging from 30° C. to 70° C., to obtain an oxime compound of formula (XVI) below:

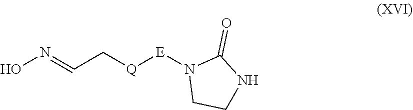

(c) a step of recovering said oxime compound of formula (XVI);

(d) a step of oxidizing the oxime compound of formula (XVI) with an oxidizing agent, in the presence of at least one organic solvent S2, the content of the oxidizing agent being at least 6 molar equivalents relative to the molar amount of oxime compound of formula (XVI).

For the purposes of the present application, a “polar solvent” is understood to mean a solvent having a dielectric constant of greater than 2.2.

For the purposes of the present application, a “nucleofugal group” is understood to mean a leaving group which carries away its bonding electron pair.

For the purposes of the present application, a “nucleophilic group” is understood to mean a compound comprising at least one atom bearing a free electron pair or one negatively charged atom.

As explained above, the process for the synthesis of the compound of formula (I) comprises in particular the successive steps (b1) and (b2).

The two steps (b1) and (b2) can be separated by a step of isolating and purifying the compound of formula (XV).

Alternatively, the two steps (b1) and (b2) can be carried out according to a one-pot synthesis, that is to say that steps (b1) and (b2) are “one-pot” (two-step one-pot synthesis process), i.e. without isolation of the intermediate compound of formula (XV).

The process comprises a step (b1) of reacting a compound of formula (XIII), as mentioned above, bearing a group Y, with a compound of formula (XIV), as mentioned above, bearing a group Z.

Preferably, the group Y is chosen from hydroxyl, thiol and primary or secondary amine functions.

The group Z can be chosen from chlorine, bromine, iodine, the mesylate group, the tosylate group, the acetate group and the trifluoromethylsulfonate group.

Said step (b1) of the process is carried out in the presence of at least one polar solvent S1 and of at least one base, at a temperature T1 ranging from 70° C. to 150° C.

The polar solvent S1 can be a water-miscible polar solvent, preferentially a protic solvent.

Dimethylformamide (DMF), dimethyl sulfoxide (DMSO), 1,3-dimethyl-2-imidazolidinone (DMI), 1,3-dimethyl-3,4,5,6-tetrahydro-2(1H)-pyrimidinone (DMPU), isopropanol, acetonitrile, ethanol, n-butanol and n-propanol are examples of solvents S1 which can be used in the process.

Preferably, the protic solvent is an alcoholic solvent.

Advantageously, the compound of formula (XIII) represents from 5% to 40% by weight, preferably from 10% to 30% by weight, relative to the weight of the solvent.

The base may be chosen from alkali metal alkoxides, alkali metal carbonates, alkaline-earth metal carbonates, alkali metal hydroxides, alkaline-earth metal hydroxides and mixtures thereof.

Advantageously, it is possible to add:
one or more catalysts selected from a catalyst of silver (I) salt type, a phase transfer catalyst of quaternary ammonium type, and mixtures thereof;
one or more ionic liquids.

Preferentially, the base is chosen from sodium methoxide, potassium carbonate and sodium hydroxide, more preferentially potassium carbonate.

According to a specific embodiment of the process, the molar amount of base is from 1.5 to 8 molar equivalents, preferably from 2 to 6 molar equivalents, relative to the molar amount of compound of formula (XIII).

As explained above, step (b1) of the process is carried out at a temperature T1 ranging from 70° C. to 150° C.

Preferably, the temperature T1 is a temperature ranging from 70° C. to 120° C., more preferentially from 80° C. to 110° C.

As explained above, step (b1) of the process is followed by step (b2) of the addition, to the reaction medium containing the compound of formula (XV), of an aqueous hydroxylamine solution at a temperature T2 ranging from 30° C. to 70° C.

Preferentially, the addition of the aqueous hydroxylamine solution is carried out when the conversion of the compound of formula (XIII) is at least 70% by weight.

Advantageously, the temperature T2 varies from 40° C. to 60° C.

The process also comprises a step (c) of recovering, as mentioned above, the oxime compound of formula (XVI).

Preferably, the oxime compound of formula (XVI) is recovered by precipitation with water, optionally followed by washing with water.

The process also comprises a step (d) of oxidizing the oxime compound of formula (XVI) with an oxidizing agent to give the compound of formula (I), in particular the preferred compounds, in the presence of at least one organic solvent S2; the amount of oxidizing agent is at least 6 molar equivalents, preferentially from 6.5 to 15 molar equivalents, relative to the molar amount of oxime compound of formula (XVI).

This amount of oxidizing agent can be added all at once or in several goes during step (d), preferably added in two goes during step (d).

Preferably, said oxidizing agent is chosen from sodium hypochlorite, N-bromosuccinimide in the presence of a base and N-chlorosuccinimide in the presence of a base; preferentially, said oxidizing agent is sodium hypochlorite.

Preferentially, the organic solvent S2 is an organic solvent chosen from chlorinated solvents and solvents of ester, ether and alcohol type, more preferentially chosen from dichloromethane, ethyl acetate, butyl acetate, diethyl ether, isopropanol and ethanol, more preferentially still chosen from ethyl acetate and butyl acetate.

Preferably, the oxime compound of formula (XVI) represents from 1% to 30% by weight, preferably from 1% to 20% by weight, relative to the total weight of the combination comprising said oxime compound of formula (XVI), said organic solvent S2 and said oxidizing agent. Preferentially, the process comprises, after step (d), a step (e) of recovering the compound of formula (I).

The process may comprise a step (a2) of manufacturing the compound of formula (XIV), prior to step (b1), by reacting a compound of formula (XVII) below with an agent enabling the formation of the nucleofugal group Z:

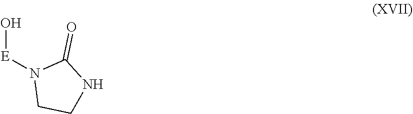

in which E is as defined above.

Preferably, said agent enabling the formation of the nucleofugal group Z is thionyl chloride.

Preferably, step (a2) is carried out in the absence or in the presence of at least one solvent S₄, preferentially a chlorinated solvent, more preferentially dichloromethane.

Advantageously, step (a2) is immediately followed by a step (a3) of recovering the compound of formula (X), preferentially by purification with toluene, more preferentially by crystallization of the compound of formula (X) from toluene.

Other processes for obtaining 1,3-dipolar compounds corresponding to formula (I) are known to those skilled in the art, in particular in document WO2012/07441.

### II-3 Filler

The composition according to the invention also has the essential feature of being based on a filler comprising predominantly silica.

The silica used in the composition according to the invention can be any silica known to those skilled in the art, in particular any precipitated or fumed silica having a BET specific surface area and a CTAB specific surface area which are both less than 450 m²/g, preferably from 30 to 400 m²/g, in particular from 60 to 300 m²/g. The silica advantageously has a BET specific surface area within a range extending from 125 to 200 m²/g and/or a CTAB specific surface area within a range extending from 140 to 170 m²/g.

The BET specific surface area of the silica is determined by gas adsorption using the Brunauer-Emmett-Teller method described in “The Journal of the American Chemical Society” (Vol. 60, page 309, February 1938), and more specifically according to a method adapted from Standard NF ISO 5794-1, Appendix E, of June 2010 [multipoint (5 point) volumetric method—gas: nitrogen—degassing under vacuum: one hour at 160° C.—relative pressure p/p₀ range: 0.05 to 0.17].

The CTAB specific surface area values of the silica were determined according to Standard NF ISO 5794-1, Appendix G of June 2010. The process is based on the adsorption of CTAB (N-hexadecyl-N,N,N-trimethylammonium bromide) on the “external” surface of the filler.

Any type of precipitated silica, in particular highly dispersible precipitated silicas (referred to as “HDS” for “highly dispersible” or “highly dispersible silica”), may be used. These precipitated silicas, whether highly dispersible or not highly dispersible, are well known to those skilled in the art. These include, for example, the silicas described in applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320 G silicas from PPG.

Advantageously, the filler comprises more than 70% by weight, preferably more than 80% by weight, of silica.

Preferably, the content of silica is within a range extending from 5 to 60 phr, preferably from 10 to 55 phr and more preferably from 15 to 50 phr.

In order to couple the silica to the copolymer, use may be made, in a well-known manner, of an at least bifunctional coupling agent (or bonding agent) intended to provide a satisfactory connection, of chemical and/or physical nature, between the silica (surface of its particles) and the copolymer (hereinafter simply referred to as “coupling agent”). Use is made in particular of organosilanes or polyorganosiloxanes that are at least bifunctional. The term “bifunctional” is understood to mean a compound having a first functional group capable of interacting with the inorganic filler and a second functional group capable of interacting with the copolymer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the copolymer.

Those skilled in the art can find examples of coupling agents in the following documents: WO 02/083782, WO 02/30939, WO 02/31041, WO 2007/061550, WO 2006/125532, WO 2006/125533, WO 2006/125534, US 6,849,754, WO 99/09036, WO 2006/023815, WO 2007/098080, WO 2010/072685 and WO 2008/055986.

The use of a coupling agent is not compulsory but is preferable. If a coupling agent is used, the content of coupling agent, in the composition according to the invention, is advantageously between 0.5% and 15% by weight relative to the weight of silica. The amount of coupling agent can easily be adjusted by a person skilled in the art according to the content of reinforcing inorganic filler used in the composition of the invention.

Advantageously, the coupling agent is an organosilane selected from the group consisting of organosilane polysulfides, polyorganosiloxanes, mercaptosilanes, acrylosilanes and methacrylosilanes.

The composition according to the invention can comprise fillers other than silica, but this is not compulsory. These may in particular be organic fillers such as carbon black.

The blacks that can be used in the context of the present invention can be any black conventionally used in pneumatic or non-pneumatic tyres or their treads (“tyre-grade” blacks). Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated in the copolymer, notably an isoprene copolymer, in the form of a masterbatch (see, for example, applications WO 97/36724 and WO 99/16600). Mixtures of several carbon blacks can also be used in the prescribed amounts.

Advantageously, the carbon black is used at a content of less than or equal to 20 phr, more preferentially less than or equal to 10 phr (for example the carbon black content may be in a range extending from 0.5 to 20 phr, in particular extending from 1 to 10 phr). Within the intervals indicated, the colouring properties (black pigmenting agent) and UV-stabilizing properties of the carbon blacks are beneficial, without, moreover, adversely affecting the typical performance qualities contributed by the reinforcing inorganic filler.

Preferably, the filler comprises between 80% and 99% by weight of silica and between 1% and 20% by weight of carbon black.

### II-4 Crosslinking System

The composition according to the invention also comprises a crosslinking system comprising at least one radical polymerization initiator, and a co-crosslinking agent selected from the group consisting of (meth)acrylate compounds, maleimide compounds, allyl compounds, vinyl compounds and mixtures thereof

### Radical Polymerization Initiator

The radical polymerization initiators are a source of free radicals necessary for the polymerization of the composition according to the invention. These compounds are well known to those skilled in the art and are described in particular in the documents WO 2002/22688 A1 and FR 2 899 808 A1, for example, as well as in the document Denisov et al. (Handbook of Free Radical Initiators, John Wiley & Sons, 2003).

Preferably, according to the invention, the at least radical polymerization initiator is selected from the group consisting of peroxides, azo compounds, redox (oxidation/reduction) systems and mixtures thereof, preferably from the group consisting of peroxides, azo compounds and mixtures thereof. More preferably, the at least radical polymerization initiator is a peroxide or a mixture of several peroxides. It can be any peroxide known to a person skilled in the art. Among the peroxides, which are well known to those skilled in the art, it is preferable to use, in the context of the present invention, an organic peroxide.

The term “organic peroxide” is understood to mean an organic compound, that is to say a compound containing carbon, comprising an —O—O— group (two oxygen atoms connected by a single covalent bond). During the crosslinking process, the organic peroxide decomposes at its unstable O—O bond to give free radicals. These free radicals make possible the creation of the crosslinking bonds.

The organic peroxide is preferably selected from the group comprising or consisting of dialkyl peroxides, monoperoxycarbonates, diacyl peroxides, peroxyketals and peroxyesters.

Preferably, the dialkyl peroxides are selected from the group comprising or consisting of dicumyl peroxide, di(t-butyl) peroxide, t-butyl cumyl peroxide, 2,5-dimethyl-2,5-di(t-butylperoxy)hexane, 2,5-dimethyl -2,5-di (t-amylperoxy)hexane, 2,5-dimethyl-2,5-di (t-butylperoxy)hex-3-yne, 2,5-dimethyl -2,5-di(t-amylperoxy)hex-3-yne, α, α′-di [(t-butylperoxy)isopropyl]benzene, α,α′-di[(t-amylperoxy)isopropyl]benzene, di(t-amyl) peroxide, 1,3,5-tri[(t-butylperoxy)i sopropyl]benzene, 1,3-dimethyl-3-(t-butylperoxy)butanol and 1,3-dimethyl-3-(t-amylperoxy)butanol.

Certain monoperoxycarbonates, such as OO-tert-butyl O-(2-ethylhexyl) monoperoxycarbonate, OO-tert-butyl O-isopropyl monoperoxycarbonate and OO-tert-amyl O-(2-ethylhexyl) monoperoxycarbonate, can also be used.

Among the diacyl peroxides, the preferred peroxide is benzoyl peroxide.

Among the peroxyketals, the preferred peroxides are selected from the group comprising or consisting of 1,1-di(t-butylperoxy)-3,3,5-trimethylcyclohexane, n-butyl 4,4-di(t-butylperoxy)valerate, ethyl 3,3-di(t-butylperoxy)butyrate, 2,2-di(t-amylperoxy)propane, 3,6,9-triethyl-3,6,9-trimethyl-1,4,7-triperoxynonane (or methyl ethyl ketone peroxide cyclic trimer), 3,3,5,7,7-pentamethyl-1,2,4-trioxepane, n-butyl 4,4-bis(t-amylperoxy)valerate, ethyl 3,3-di(t-amylperoxy)butyrate, 1,1-di(t-butylperoxy)cyclohexane, 1,1-di(t-amylperoxy)cyclohexane and mixtures thereof. Preferably, the peroxyesters are selected from the group consisting of tert-butyl peroxybenzoate, tert-butyl peroxy-2-ethylhexanoate and tert-butyl peroxy-3,5,5-trimethylhexanoate.

To summarize, the organic peroxide is, particularly preferably, selected from the group consisting of dicumyl peroxide, aryl or diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane, n-butyl 4,4-di(tert-butylperoxy)valerate, OO-(t-butyl) O-(2-ethylhexyl) monoperoxycarbonate, tert-butylperoxy isopropyl carbonate, tert-butyl peroxybenzoate, tert-butyl peroxy-3,5,5-trimethylhexanoate, 1,3(4)-bis(tert-butylperoxyisopropyl)benzene and mixtures thereof. More preferably, the organic peroxide is selected from the group consisting of from the group consisting of dicumyl peroxide, n-butyl 4,4-di(tert-butylperoxy)valerate, OO-(t-butyl) O-(2-ethylhexyl) monoperoxycarbonate, tert-butylperoxy isopropyl carbonate, tert-butyl peroxybenzoate, tert-butyl peroxy-3,5,5-trimethylhexanoate, 1,3(4)-bis(tert-butylperoxyisopropyl)benzene and mixtures thereof.

Mention may be made, as examples of commercially available peroxides which can be used in the context of the present invention, of Dicup from Hercules Powder Co., Perkadox Y12 from Noury van der Lande, Peroximon F40 from Montecatini Edison S.p.A., Trigonox from Noury van der Lande, Varox from R.T.Vanderbilt Co. or else Luperko from Wallace & Tiernan Inc.

The term “azo compound” is understood to mean a compound, the molecular structure of which contains at least one —N═N— bond (two nitrogen atoms connected by a covalent double bond).

Preferably, the azo compound is selected from the group consisting of 2,2′-azobis(isobutyronitrile), 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl]propionamide, 2,2′-azobis(N, N′-dimethyleneisobutyramidine) dichloride, 2,2′-azobis(2-amidinopropane) dichloride, 2,2′-azobis(N,N′-dimethyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide) dihydrate and mixtures thereof.

Mention may be made, as an example of a commercially available azo compound which can be used in the context of the present invention, of 2,2′-azobis(isobutyronitrile) from Sigma-Aldrich.

The term “redox systems” is understood to mean a combination of compounds bringing about an oxidation-reduction reaction which generates radicals.

They can, for example, be combinations of peroxides with tertiary amines (for example the pairs: benzoyl peroxide plus dimethylaniline); of hydroperoxides with transition metals (such as the cumene hydroperoxide plus cobalt naphthenate mixture).

Advantageously, the content of radical initiator, preferably of organic peroxide, in the composition according to the invention is within a range extending from 0.1 to 10 phr, preferably from 0.1 to 3 phr, more preferably from 0.2 to 2.5 phr.

The content of radical polymerization initiator in the composition is preferably within a range extending from 1% to 10% by weight, preferably between 1.25% and 8% by weight, preferably between 2% and 5% by weight, preferably between 3% and 4% by weight, relative to the weight of co-crosslinking agent.

### Co-Crosslinking Agent

According to the invention, the co-crosslinking agent is selected from the group consisting of (meth)acrylate compounds, maleimide compounds, allyl compounds, vinyl compounds and mixtures thereof.

Preferably, the co-crosslinking agent comprises a (meth)acrylate compound, in the form of metal salt, or of ester or in polymeric form.

More preferably, the co-crosslinking agent comprises an acrylate derivative of formula (XI):

[X]ₚA (XI)

in which:
[X]ₚ corresponds to a radical of formula (XII):

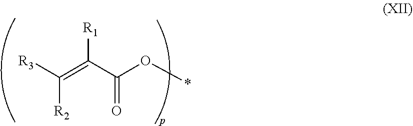

in which:
R₁, R₂ and R₃ independently represent a hydrogen atom or a C₁-C₈ hydrocarbon group selected from the group consisting of alkyl groups which are linear, branched or cyclic, alkylaryl groups, aryl groups and aralkyls, and which are optionally interrupted by one or more heteroatoms, it being possible for R₂ and R₃ together to form a non-aromatic ring,
(*) represents the point of attachment of the radical of formula (XII) to A,
A represents an atom belonging to the group consisting of alkaline earth metals or transition metals, a carbon atom or a C₁-C₃₀ hydrocarbon group, optionally interrupted and/or substituted by one or more heteroatoms,
A comprising p free valencies, p having a value ranging from 2 to 6,
it being understood that the 2 to 6 X radicals are identical or different.

According to the invention, the bond between X and A can be an ionic bond or a covalent bond. A person skilled in the art clearly understands that, when A represents an atom belonging to the group consisting of alkaline earth metals and transition metals, in particular Zn or Mg, the bond between X and A is an ionic bond. Furthermore, when A represents a carbon atom or a C₁-C₃₀ hydrocarbon group, a person skilled in the art clearly understands that the bond between X and A is a covalent bond.

A cyclic alkyl group is understood to mean an alkyl group comprising one or more rings.

A hydrocarbon group or chain interrupted by one or more heteroatoms is understood to mean a group or chain comprising one or more heteroatoms, each heteroatom being between two carbon atoms of said group or of said chain, or between a carbon atom of said group or of said chain and another heteroatom of said group or of said chain, or between two other heteroatoms of said group or of said chain.

A hydrocarbon group or chain substituted by one or more heteroatoms is understood to mean a group or chain comprising one or more heteroatoms, each heteroatom being bonded to the hydrocarbon group or chain by a covalent bond without interrupting the hydrocarbon group or chain.

The heteroatom(s) of A can be selected from the group consisting of oxygen, sulfur, nitrogen, silicon and phosphorus atoms and combinations thereof. Preferably, the heteroatom(s) of A are selected from the group consisting of oxygen and sulfur atoms. More preferably, the heteroatom(s) of A are oxygen atoms.

In other words, A advantageously represents a linear, branched or cyclic C₄-C₃₀ hydrocarbon group interrupted and/or substituted by one or more heteroatoms chosen from oxygen, sulfur, nitrogen, silicon or phosphorus atoms and combinations thereof, preferably selected from the group consisting of oxygen and sulfur atoms. More preferably, A advantageously represents a linear, branched or cyclic, preferably linear or branched, C₄-C₃₀ hydrocarbon group interrupted and/or substituted by one or more oxygen and/or sulfur atoms, preferably interrupted and/or substituted by one or more oxygen atoms.

Preferably, A represents a linear, branched or cyclic, preferably linear or branched, C₄ -C₃₀ hydrocarbon group interrupted by one or more oxygen and/or sulfur atoms, preferably interrupted by one or more oxygen atoms. More preferably, A represents a linear or branched C₄-C₃₀ hydrocarbon group interrupted by one or more oxygen atoms.

When A represents a C₄-C₃₀ hydrocarbon group, it can, for example, be a C₅-C₂₀, preferably C₆-C₁₆, hydrocarbon group.

When A comprises a cyclic hydrocarbon group, it can be a non-aromatic or aromatic cyclic hydrocarbon group.

The heteroatom(s) of the R₁, R₂, R₃ and A radicals can be, independently of one another, oxygen, sulfur, nitrogen, phosphorus or silicon atoms, preferably oxygen or nitrogen atoms.

Whatever the nature of the A radical, R₁, R₂ and R₃ can represent, independently of one another, a hydrogen atom, a methyl group or an ethyl group; preferably, R₁, R₂ and R₃ represent, independently of one another, a hydrogen atom or a methyl group.

Advantageously, R₁ can represent a methyl group and R₂ and R₃ can each represent a hydrogen atom. Alternatively, R₁, R₂ and R₃ can each represent a hydrogen atom.

The valency number p depends on the nature of the A radical. According to the invention, p may be 2, 3, 4, 5 or 6. Preferably, p is 2, 3 or 4, preferably 2 or 3, preferably 2.

Advantageously, whatever the R₁, R₂ and R₃ groups:
A represents an atom belonging to the group consisting of alkaline earth metals or transition metals, a carbon atom or a C₁-C₁₃, preferably C₁-C₈, hydrocarbon group,
A comprising p free valencies, p having a value ranging from 2 to 4,
it being understood that the 2 to 4 X radicals of the acrylate derivative of formula (VIII) are identical or different, preferably identical.

According to the invention, when A represents an atom belonging to the group consisting of alkaline earth metals or transition metals, it can, for example, be an atom selected from the group consisting of Zn and Mg.

When A represents a C₁-C₁₃, preferably C₁-C₈, hydrocarbon group, it can, for example, be a C₁-C₇, preferably C₁-C₆, hydrocarbon group.

Preferably, A represents a C₁-C₁₃ hydrocarbon group selected from the group consisting of the following radicals:

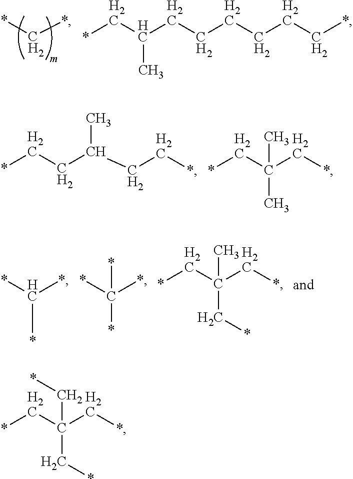

in which m is an integer ranging from 1 to 13, and (*) represents the point of attachment of A to the radical of formula (IX).

Advantageously, the C₁-C₁₃ hydrocarbon group is a *—(CH₂)ₘ—* radical in which m is an integer ranging from 1 to 13, preferably from 1 to 8, preferably from 1 to 6, and (*) represents the point of attachment of A to the radical of formula (IX).

Thus, according to the invention, the acrylate derivative of formula (VIII) can be chosen from zinc dimethacrylate (ZDMA), magnesium dimethacrylate (MgDMA), zinc diacrylate (ZDA), magnesium diacrylate (MgDA), trimethylolpropane trimethacrylate (TMPTMA), trimethylolpropane triacrylate (TMPTA), 1,6-hexanediol diacrylate (HDDA) and mixtures thereof.

Examples which are available commercially are diacrylate derivatives, such as zinc diacrylate (ZDA), Dymalink 633 from Cray Valley, zinc dimethacrylate (ZDMA), Dymalink 634 from Cray Valley, trimethylolpropane trimethacrylate (TMPTMA), SR₃₅₁ from Sartomer, or 1,6-hexanediol diacrylate (HDDA) from Sigma-Aldrich.

Advantageously, the content of co-crosslinking agent, and preferably the total content of co-crosslinking agent, in the composition according to the invention is within a range extending from 1 to 20 phr, preferably from 2 to 10 phr, preferably between 2 and 5 phr.

Advantageously, the amount of radical polymerization initiator in the composition is within a range extending from 1% to 10% by weight, preferably between 1.25% and 8% by weight, preferably between 2% and 5% by weight, preferably between 3% and 4% by weight, relative to the weight of co-crosslinking agent in the composition.

Also advantageously, the ratio of the content of silica to the content of co-crosslinking agent is within a range extending from 2 to 9, preferably from 3 to 7.

### Sulfur

Furthermore, the composition according to the invention is advantageously free of sulfur as vulcanization agent, or contains less than 0.5 phr, preferably less than 0.3 phr, preferably less than 0.2 phr and preferably less than 0.1 phr thereof. The sulfur can be molecular sulfur or can originate from a sulfur-donating agent, such as alkylphenol disulfides (APDSs).

### II-5 Possible Additives

The rubber compositions may optionally also comprise all or some of the usual additives customarily used in elastomer compositions for tyres, such as for example plasticizers (such as plasticizing oils and/or plasticizing resins), pigments, protective agents such as anti-ozone waxes, chemical anti-ozonants, antioxidants, anti-fatigue agents, reinforcing resins (as described for example in application WO 02/10269).

### II-6 Preparation of the rubber compositions

The compositions in accordance with the invention can be manufactured in appropriate mixers using two successive preparation phases well known to those skilled in the art:
a first phase of thermomechanical working or kneading (“non-productive” phase), that can be carried out in a single thermomechanical step during which all the necessary constituents, in particular the elastomer matrix, the filler, the co-crosslinking agent and the optional other various additives, with the exception of the radical polymerization initiator, are introduced into an appropriate mixer, such as a standard internal mixer (for example of ‘Banbury’ type). The incorporation of the optional filler into the elastomer can be carried out in one or more goes by thermomechanically kneading. In the case where the filler is already incorporated, in full or in part, in the elastomer in the form of a masterbatch, as is described, for example, in applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which is carried out in an external mixer, such as an open mill, after cooling the mixture obtained during the first 20 non-productive phase down to a lower temperature, typically of less than 120° C., for example between 40° C. and 100° C. The radical polymerization initiator is then incorporated and the combined mixture is then mixed for a few minutes, for example between 5 and 15 min.

Such phases have been described, for example, in applications EP-A-0501227, EP-A-0735088, EP-A-0810258, WO 00/05300 or WO 00/05301.

The final composition thus obtained is then calendered, for example in the form of a sheet or of a slab, in particular for characterization in the laboratory, or else extruded (or co-extruded with another rubber composition) in the form of a rubber semi-finished product (or profiled element) which can be used, for example, as a tyre tread. These products can subsequently be used for the manufacture of tyres, according to techniques known to those skilled in the art.

The crosslinking of the composition can be carried out in a manner known to those skilled in the art, for example at a temperature of between 130° C. and 200° C., under pressure.

Also described in the present document is a process for preparing the rubber composition in accordance with the invention further comprising a crosslinking system comprising the following steps:
adding, during a first “non-productive” stage, to the copolymer, the 1,3-dipolar compound, the filler and the co-crosslinking agent, by kneading thermomechanically until a maximum temperature of between 130° C. and 200° C. is reached,
cooling the combined mixture to a temperature belowe 100° C.,
subsequently incorporating the radical polymerization initiator,
kneading the combined mixture up to a maximum temperature below 120° C.

The amount of 1,3-dipolar compound added is preferentially between 0 and 3 molar equivalents, more preferentially between 0 and 2 molar equivalents, more preferentially still between 0 and 1 molar equivalent, indeed even more preferably still between 0 and molar equivalents, of imidazole ring per 100 moles of monomer units constituting the copolymer. For each of these preferred ranges, the lower limit is preferably at least molar equivalents of 1,3-dipolar compound.

Advantageously, the 1,3-dipolar compound is mixed with the copolymer before the introduction of the other constituents of the rubber composition, in particular before the addition of the filler. The contact time between the copolymer and the 1,3-dipolar compound which are intimately mixed, in particular thermomechanically kneaded, is adjusted as a function of the conditions of the mixing, in particular of the thermomechanical kneading, notably as a function of the temperature. The higher the temperature, the shorter this contact time. Typically, it is from 1 to 5 minutes for a temperature of 100° C. to 130° C.

Preferably, at least one antioxidant is preferably added to the copolymer before it is introduced into a mixer, in particular at the end of the synthesis of the copolymer, as is done conventionally.

After incorporating all the ingredients of the rubber composition, the final composition thus obtained is then calendered, for example in the form of a sheet or slab, in particular for laboratory characterization, or else extruded, in order to form, for example, a rubber profiled element that is used as rubber component for the manufacture of the tyre.

### II-7 Rubber Articles

Another subject of the present invention is a rubber article comprising at least one composition according to the invention.

Given the improved performance compromise within the context of the present invention, the rubber article is advantageously selected from the group consisting of pneumatic tyres, non-pneumatic tyres, caterpillar tracks and conveyor belts. Preferably, the rubber article is a pneumatic or non-pneumatic tyre.

More particularly, another subject of the invention is a pneumatic or non-pneumatic tyre provided with a tread comprising at least one composition according to the invention.

Another subject of the invention is a rubber caterpillar track comprising at least one rubber element comprising at least one composition according to the invention, the at least one rubber element being preferably an endless rubber belt or a plurality of rubber pads, and also a rubber conveyor belt comprising a composition according to the invention.

The invention relates to the rubber articles described above both in the raw state (that is to say, before curing) and in the cured state (that is to say, after crosslinking or vulcanization).

### III—PREFERRED EMBODIMENTS

In the light of the above, the preferred embodiments of the invention are described below:

1. Rubber composition based on at least:
an elastomer matrix comprising more than 50 phr of a copolymer containing ethylene units and 1,3-diene units, the ethylene units in the copolymer representing more than mol % of the monomer units of the copolymer,
a 1,3-dipolar compound corresponding to the formula (I):

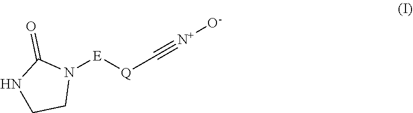

in which:
Q represents an arenediyl ring optionally substituted by one or more identical or different, preferably saturated, linear or branched aliphatic hydrocarbon chains, which are optionally substituted or interrupted by one or more heteroatoms,
E represents a divalent hydrocarbon group optionally comprising one or more heteroatoms,
a filler comprising predominantly silica, and
a crosslinking system comprising at least one radical polymerization initiator, and a co-crosslinking agent selected from the group consisting of (meth)acrylate compounds, maleimide compounds, allyl compounds, vinyl compounds and mixtures thereof.

2. Composition according to embodiment 1, in which the ethylene units in the copolymer represent between 50 mol % and 95 mol %, preferably between 55 mol % and 90 mol %, of the monomer units of the copolymer.

3. Composition according to either one of the preceding embodiments, in which the copolymer containing ethylene units and 1,3-diene units is a copolymer of ethylene and of 1,3-diene.

4. Composition according to any one of the preceding embodiments, in which the 1,3-diene is 1,3-butadiene.

Composition according to any one of the preceding embodiments, in which the copolymer contains units of formula (II) or units of formula (III) or else units of formula (II) and of formula (III):

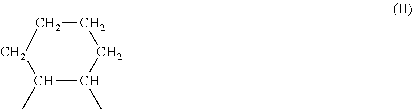

—CH₂—CH(CH═CH2)— (III)

6. Composition according to any one of the preceding embodiments, in which the molar percentages of the units of formula (II) and of the units of formula (III) in the copolymer, respectively o and p, satisfy the following equation (eq. 1), preferentially satisfy the equation (eq. 2), o and p being calculated on the basis of all the monomer units of the copolymer.

1<o+p≤25 (eq. 1)

1<o+p<20 (eq. 2)

7. Composition according to any one of the preceding embodiments, in which the copolymer containing ethylene units and 1,3-diene units is a random copolymer.

8. Composition according to any one of the preceding embodiments, wherein the content of the copolymer containing ethylene units and 1,3-diene units is within a range extending from 60 to 100 phr, preferably from 80 to 100 phr.

9. Composition according to any one of the preceding embodiments, in which the compound of formula (I) is chosen from the compounds of formula (Ia) and (Ib):

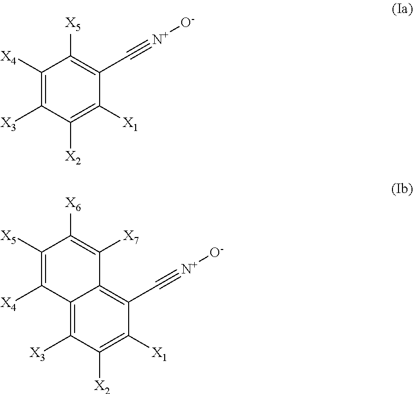

in which:
four groups of formula (Ia) chosen from X₁ to X₅ and six groups of formula (Ib) chosen from X₁ to X₇, which may be identical or different, represent a hydrogen atom, ahalogen atom or a, preferably saturated, linear or branched aliphatic hydrocarbon chain optionally substituted or interrupted by one or more heteroatoms,
a group chosen from X₁ to X₅ of formula (Ia) and a group chosen from X₁ to X₇ of formula (Ib) denote a covalent bond enabling attachment to the group E of the group of formula (IV) below:

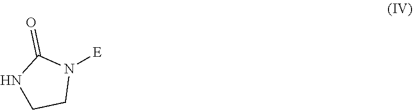

Composition according to any one of the preceding embodiments, in which the group E is a, preferably saturated, linear or branched C₁-C₂₄, preferably C₁-C₁₀, more preferentially C₁-C₆, hydrocarbon chain optionally interrupted by one or more nitrogen, sulfur or oxygen atoms.

11. Composition according to any one of the preceding embodiments, in which the 1,3-dipolar compound is chosen from the compounds of formulae (V) to (X) below and the mesomeric forms thereof:

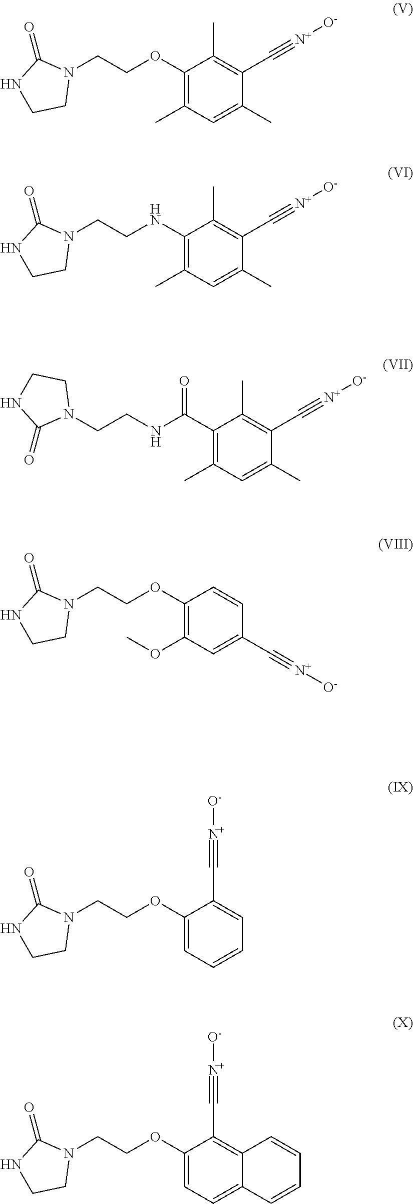 [SMILES: Cc1cc(C)c(OCCN2CCNC2=O)c(C)c1C#[N+][O-] ; Cc1cc(C)c(NCCN2CCNC2=O)c(C)c1C#[N+][O-] ; Cc1cc(C)c(C(=O)NCCN2CCNC2=O)c(C)c1C#[N+][O-] ; COc1cc(C#[N+][O-])ccc1OCCN1CCNC1=O ; O=C1NCCN1CCOc1ccccc1C#[N+][O-] ; O=C1NCCN1CCOc1ccc2ccccc2c1C#[N+][O-]]

12. Composition according to embodiment 11, in which the 1,3-dipolar compound is chosen from the compounds of formulae (V), (IX) and (X) and the mesomeric forms thereof:

13. Composition according to any one of the preceding embodiments, in which the content of 1,3-dipolar compound is between 0 and 50 molar equivalents, preferably between 0.01 and 15 molar equivalents, for example between 4 and 15 molar equivalents, per 100 moles of monomer units constituting the copolymer.

14. Composition according to any one of embodiments 1 to 12, in which the content of 1,3-dipolar compound is between 0.1 and 3 molar equivalents, preferentially between 0.1 and 2 molar equivalents, even more preferentially between 0.1 and 1 molar equivalent, indeed even more preferentially between 0.1 and 0.7 molar equivalents, of imidazole ring per 100 moles of monomer units constituting the diene elastomer.

15. Composition according to any one of the preceding embodiments, in which the filler comprises more than 70% by weight, preferably more than 80% by weight, of silica.

16. Composition according to any one of the preceding embodiments, in which the filler comprises between 80% and 99% by weight of silica and between 1% and 20% by weight of carbon black.

17. Composition according to any one of the preceding embodiments, in which the content of silica is within a range extending from 5 to 60 phr, preferably from 10 to 55 phr, more preferably from 15 to 50 phr.

18. Composition according to any one of the preceding embodiments, further comprising an agent for coupling the silica to the copolymer, the coupling agent preferably being an organosilane selected from the group consisting of organosilane polysulfides, polyorganosiloxanes, mercaptosilanes, acrylosilanes and methacrylosilanes.

19. Composition according to any one of the preceding embodiments, in which the radical polymerization initiator is selected from the group consisting of peroxides, azo compounds, redox (oxidation/reduction) systems and mixtures thereof.

20. Composition according to any one of the preceding embodiments, in which the radical polymerization initiator is an organic peroxide selected from the group consisting of dicumyl peroxide, aryl or diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane, n-butyl 4,4′-di(tert-butylperoxy)valerate, OO-(t-butyl) O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3(4)-bis(tert-butylperoxyisopropyl)benzene and mixtures thereof, preferably from the group consisting of dicumyl peroxide, n-butyl 4,4′ -di(tert-butylperoxy)valerate, OO-(t-butyl) O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3(4)-bis(tert-butylperoxyisopropyl)benzene and mixtures thereof.

21. Composition according to any one of the preceding embodiments, in which the content of radical polymerization initiator is within a range extending from 0.1 to 3 phr, preferably from 0.2 to 2.5 phr.

22. Composition according to any one of the preceding embodiments, in which the content of radical polymerization initiator is within a range extending from 1% to 10% by weight, preferably between 1.25% and 8% by weight, preferably between 2% and 5% by weight, preferably between 3% and 4% by weight, relative to the weight of co-crosslinking agent.

23. Composition according to any one of the preceding embodiments, in which the co-crosslinking agent comprises an acrylate derivative of formula (XI):

[X]ₚA (XI)

in which:
[X]ₚ corresponds to a radical of formula (XII):

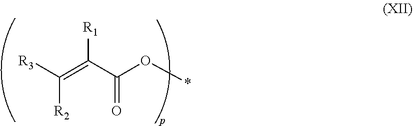

in which:
R₁, R₂ and R₃ independently represent a hydrogen atom or a C₁-C₈ hydrocarbon group selected from the group consisting of alkyl groups which are linear, branched or cyclic, alkylaryl groups, aryl groups and aralkyls, and which are optionally interrupted by one or more heteroatoms, it being possible for R₂ and R₃ together to form a non-aromatic ring,
   (*) represents the point of attachment of the radical of formula (XII) to A,
A represents an atom belonging to the group consisting of alkaline earth metals or transition metals, a carbon atom or a C₁-C₃₀ hydrocarbon group, optionally interrupted and/or substituted by one or more heteroatoms,
A comprising p free valencies, p having a value ranging from 2 to 6,
it being understood that the 2 to 6 X radicals are identical or different.

24. Composition according to embodiment 23, in which, in the acrylate derivative of formula (XI):
A represents an atom belonging to the group consisting of alkaline earth metals or transition metals, a carbon atom or a C₁-C₁₃ hydrocarbon group,
A comprising p free valencies, p having a value ranging from 2 to 4,
it being understood that the 2 to 4 X radicals are identical or different.

25. Composition according embodiment 23 or 24, in which R₁, R₂ and R₃ represent, independently of one another, a hydrogen atom, a methyl group or an ethyl group.

26. Composition according to any one of embodiments 23 to 25, in which R₁ represents a methyl group and R₂ and R₃ each represent a hydrogen atom.

27. Composition according to any one of embodiments 23 to 25, in which R₁, R₂ and R₃ each represent a hydrogen atom.

28. Composition according to any one of the embodiments 23 to 27, in which p is 2 or 3, preferably 2.

29. Composition according to any one of embodiments 23 to 27, in which A represents an atom selected from the group consisting of Zn and Mg.

30. Composition according to any one of embodiments 23 to 27, in which A represents a C₁-C₁₃ hydrocarbon group selected from the group consisting of the following radicals:

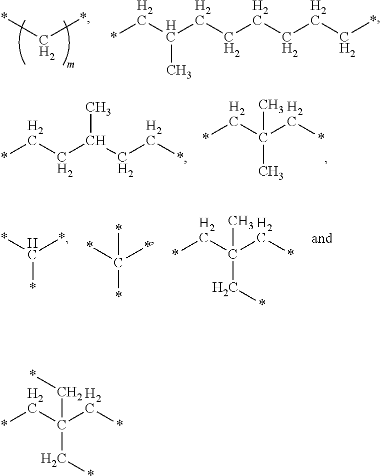

in which m is an integer ranging from 1 to 13, and (*) represents the point of attachment of A to the radical of formula (XII).

31. Composition according to any one of the preceding embodiments, in which the content of co-crosslinking agent is within a range extending from 1 to 20 phr, preferably from 2 to 10 phr, preferably between 2 and 5 phr.

32. Composition according to any one of the preceding embodiments, in which the ratio of the content of silica to the content of co-crosslinking agent is within a range extending from 2 to 9, preferably from 3 to 7.

33. Composition according to any one of the preceding embodiments, in which the composition does not contain molecular sulfur or sulfur-donating agent as vulcanizing agent or contains less than 0.5 phr, preferably less than 0.3 phr, more preferably less than 0.1 phr thereof.

34. Rubber article comprising a composition as defined in any one of embodiments 1 to 33.

35. Rubber article according to embodiment 34, said article being selected from the group consisting of pneumatic tyres, non-pneumatic tyres, rubber caterpillar tracks and conveyor belts.

36. Pneumatic or non-pneumatic tyre comprising a composition as defined in any one of embodiments 1 to 33.

37. Pneumatic or non-pneumatic tyre according to embodiment 36, in which the composition defined in any one of embodiments 1 to 33 is present in the tread.

### IV—EXAMPLES

### IV-1 Measurements and Tests Used

### Determination of the Molar Masses: Size Exclusion Chromatography Analysis of the Copolymers

a) For the copolymers which are soluble at room temperature in tetrahydrofuran (THF), the molar masses were determined by size exclusion chromatography in THF. The samples were injected using a Waters 717 injector and a Waters 515 HPLC pump at a flow rate of 1 ml·min'in a series of Polymer Laboratories columns. This series of columns, placed in a chamber thermostatically maintained at 45° C., is composed of:
1 PL Gel 5 μm precolumn,
2 PL Gel 5 μm Mixed C columns,
1 PL Gel 5 μm-500 Å column.

The detection was performed using a Waters 410 refractometer. The molar masses were determined by universal calibration using polystyrene standards certified by Polymer Laboratories and a double detection with a refractometer and coupling to the viscometer.

Without being an absolute method, SEC makes it possible to comprehend the molecular mass distribution of a polymer. On the basis of standard commercial products of polystyrene type, the various number-average masses (Mn) and weight-average masses (Mw) can be determined and the polydispersity index calculated (PI=Mw/Mn).

b) For the copolymers which are insoluble in tetrahydrofuran at ambient temperature, the molar masses were determined in 1,2,4-trichlorobenzene. They were first dissolved under hot conditions (4 hours at 150° C.) and were then injected at 150° C., at a flow rate of 1 ml·min⁻¹, into a Waters Alliance GPCV 2000 chromatograph equipped with three Styragel columns (two HT6E columns and one HT2 column). The detection was performed using a Waters refractometer. The molar masses were determined by relative calibration using polystyrene standards certified by Polymer Laboratories.

### Determination of the Mole Fractions

Reference is made to the article “Investigation of ethylene/butadiene copolymers microstructure by ¹H and ¹³C NMR”, Llauro M. F., Monnet C., Barbotin F., Monteil V., Spitz R., Boisson C., Macromolecules 2001, 34, 6304-6311″, for a detailed description of the H NMR and ¹³C NMR techniques which have been specifically used in the present application to determine the mole fractions of the ethylene units, the conjugated diene units and of any trans-1,2-cyclohexane units.

### NMR Analysis

The structural analysis and also the determination of the molar purities of the molecules synthesized are carried out by an NMR analysis. The spectra are acquired on a Bruker Avance 3400 MHz spectrometer equipped with a 5 mm BBFO Z-grad “broad band” probe. The quantitative ¹H-NMR experiment uses a simple 30° pulse sequence and a repetition time of 3 seconds between each of the 64 acquisitions. The samples are dissolved in deuterated dimethyl sulfoxide (DMSO). This solvent is also used for the lock signal. Calibration is carried out on the signal of the protons of the deuterated DMSO at 2.44 ppm with respect to a TMS reference at 0 ppm. The ¹HNMR spectrum coupled with the 2D ¹H/¹³C HSQC and ¹H/¹³C HMBC experiments enables the structural determination of the molecules (cf. assignment tables). The molar quantifications are performed from the quantitative 1D ¹H NMR spectrum.

### Mooney M L 1+4

The Mooney plasticity measurement is carried out according to the following principle and in accordance with Standard ASTM D-1646. The generally raw polymer is moulded in a cylindrical chamber heated to a given temperature, usually 100° C. After preheating for one minute, an L-type rotor rotates within the test specimen at 2 revolutions/minute and the working torque for maintaining this movement is measured after rotating for 4 minutes. The Mooney plasticity (ML 1+4) is expressed in “Mooney units” (MU, where 1 MU=0.83 newton·metre).

### Dynamic Properties (After Curing): Tensile tTest

These tensile tests make it possible to determine the elasticity stresses and the properties at break. Unless otherwise indicated, they are carried out in accordance with French Standard NF T 46-002 of September 1988. Processing the tensile recordings also makes it possible to plot the curve of modulus as a function of the elongation. The modulus used here is the nominal (or apparent) secant modulus measured in first elongation, calculated by normalizing to the initial cross section of the test specimen. The nominal secant moduli (or apparent stresses, in MPa) are measured in first elongation at 100% and 300% elongation, respectively denoted MSA100 and MSA300. The reinforcement index, which is the ratio of the MSA300 modulus to the MSA100 modulus, is expressed in base 100 relative to the control composition T1. A value greater than 100 expresses an improvement in the reinforcement of the composition under consideration compared with the control composition.

The elongation at break (EB %) and breaking stress (BS) tests are based on Standard NF ISO 37 of December 2005 on an H2 dumbbell test specimen and are measured at a tensile speed of 500 mm/min. The elongation at break is expressed as a percentage of elongation. The breaking stress is expressed in MPa. These values are expressed in base 100 relative to the control composition T1. A value greater than 100 expresses an improvement in the mechanical properties of the composition under consideration compared with the control composition.

All these tensile measurements are carried out under the standard conditions of temperature (23±2° C.) and hygrometry (50 35 5% relative humidity), according to French standard NF T 40-101 (December 1979).

The dynamic properties G* and tan(δ)max were measured on a viscosity analyser (Metravib VA4000) according to Standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under defined temperature conditions, for example at 60° C., according to Standard ASTM D 134999, is recorded. A strain amplitude sweep was carried out from 0.15% to 50% (outward cycle) and then from 50% to 0.15% (return cycle). The results made use of are the non-linearity (NL or AΔG*) and the loss factor tan(δ). The maximum value of tan(δ) observed, denoted tan(δ)max is indicated for the return cycle. The non-linearity (NL or ΔG*) is the difference in shear modulus between 0.15% and 50% strain, expressed in MPa. The non-linearity and tan(δ)max are expressed in base 100 relative to the control composition T1. A value of less than 100 expresses an improvement in the hysteresis and therefore in the rolling resistance of the composition under consideration compared with the control composition.

### IV-2 Preparation of the Compositions

In the examples which follow, the rubber compositions were produced as described in point II-6 above. In particular, these compositions are manufactured in the following way: the elastomer, where appropriate the 1,3-dipolar compound, which is kneaded alone with the elastomer at 110° C. for around 2 minutes, then the silica, the coupling agent, the co-crosslinking agent and also the various other ingredients, with the exception of the peroxide, are introduced into an internal mixer (final degree of filling: around 70% by volume), the initial vessel temperature of which is around 110° C. Thermomechanical working (non-productive phase) is then carried out in one step, which lasts around 5 to 6 min, until a maximum “dropping” temperature of 160° C. is reached. The mixture thus obtained is recovered and cooled and then the peroxide is incorporated on a mixer (homofinisher) at 23° C., everything being mixed (productive phase) for an appropriate time (for example between 5 and 12 min).

The compositions thus obtained are subsequently calendered, either in the form of plaques (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tyres, in particular for treads.

The crosslinking is carried out at 150° C. The crosslinking time applied, t′_{c}(90), is the time necessary for the torque of the composition to reach 90% of the maximum torque of the composition. The torques of the composition are measured at 150° C. with an oscillating disc rheometer, according to Standard DIN 53529-Part 3 (June 1983). t′_{c}(90) is determined according to standard NF T 43-015 for each of the compositions. It varies approximately from 20 to 40 minutes from one composition to another.

### IV-3 Tests on Rubber Compositions

The object of the examples presented below is to compare the performance compromise between the reinforcement, the breaking stress and the rolling resistance of a composition in accordance with the present invention (C₁) with three control competitions (T1 to T3).

The compositions tested (in phr), as well as the results obtained, are presented in Table 1.

The control compositions differ from composition C1 in accordance with the invention in that they do not comprise a 1,3-dipolar compound and/or a co-crosslinking agent in accordance with the invention.

TABLE 1

| Components | T1 | T2 | T3 | C1 |
|---|---|---|---|---|
| EBR(1) | 100 | 100 | 100 | 100 |
| 1,3-Dipolar compound (2) | — | 2.1 | — | 2.1 |
| Silica (3) | 30 | 30 | 30 | 30 |
| Coupling agent (4) | 3 | 3 | 3 | 3 |
| Peroxide (5) | 1.6 | 1.6 | 1.6 | 1.6 |
| Co-crosslinking agent (6) | — | — | 5 | 5 |
| Properties | | | | |
| MSA300/MSA100 | 100 | 101 | 338 | 403 |
| BS at 23° C. | 100 | 110 | 176 | 163 |
| NL at 60° C. | 100 | 48 | 118 | 39 |

(1) Elastomer containing 79 mol % of ethylene units, 7 mol % of 1,2-cyclohexanediyl units, 8 mol % of 1,2 units, and 6 mol % of 1,4 units; Mooney at 100° C.: 60; Mn: 156 600 g/mol
(2) 1,3-Dipolar compound, the synthesis of which is described in paragraph 1.1, pages 15 to 23, of document WO 2012/07441
(3) Silica, Zeosil 1165MP from Solvay
(4) Triethoxysilylpropyltetrasulfide (TESPT) liquid silane, Si69 from Evonik
(5) 1,1-Bis(tert-butylperoxy)-3,5,5-trimethylcyclohexane, Luperox 231 XL40 from Arkema
(6) Hexanediol diacrylate (HDDA), SR238 from Sartomer

The results presented in Table 1 above show that the specific combination of a 1,3-dipolar compound and of a co-crosslinking agent in accordance with the invention in a composition based on a highly saturated diene elastomer crosslinked with peroxide makes it possible to greatly improve the reinforcement of the composition and the rolling resistance, while exhibiting an improved breaking stress compared to the control composition T1.

The compositions in accordance with the invention are useful for numerous applications in the field of pneumatic or non-pneumatic tyres, in particular in treads for which a good compromise between the performance in terms of reinforcement, breaking stress and rolling resistance rolling resistance is desired.

1.-15. (canceled)

16. A rubber composition based on at least:
an elastomer matrix comprising more than 50 phr of a copolymer containing ethylene units and 1,3-diene units, the ethylene units in the copolymer representing more than 50 mol % of monomer units of the copolymer;
a 1,3-dipolar compound corresponding to formula (I): 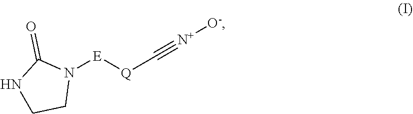
in which Q represents an arenediyl ring optionally substituted by one or more identical or different linear or branched aliphatic hydrocarbon chains, which are optionally substituted or interrupted by one or more heteroatoms, and E represents a divalent hydrocarbon group optionally comprising one or more heteroatoms;
a filler comprising predominantly silica; and
a crosslinking system comprising at least one radical polymerization initiator and a co-crosslinking agent selected from the group consisting of (meth)acrylate compounds, maleimide compounds, allyl compounds, vinyl compounds and mixtures thereof.

17. The rubber composition according to claim 16, wherein the compound of formula (I) is selected from compounds of formula (Ia) and (Ib): 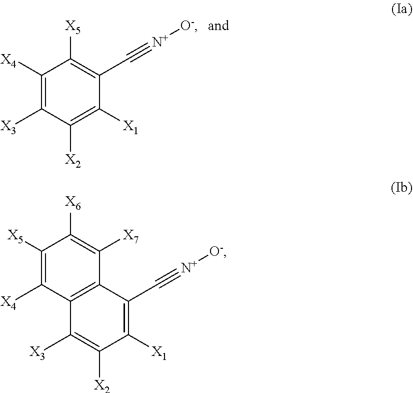
in which four groups of formula (Ia) chosen from X₁ to X₅ and six groups of formula (Ib) chosen from X₁ to X₇, which may be identical or different, represent a hydrogen atom, a halogen atom or a linear or branched aliphatic hydrocarbon chain optionally substituted or interrupted by one or more heteroatoms, and
a group chosen from X₁ to X₅ of formula (Ia) and a group chosen from X₁ to X₇ of formula (Ib) denote a covalent bond enabling attachment to group E of formula (IV) below:

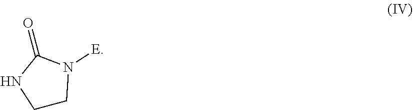

18. The rubber composition according to claim 16, wherein group E is a linear or branched C₁-C₂₄ hydrocarbon chain optionally interrupted by one or more nitrogen, sulfur or oxygen atoms.

19. The rubber composition according to claim 16, wherein the 1,3-dipolar compound is selected from the group of compounds of formulae (V) to (X) below and the mesomeric forms thereof:

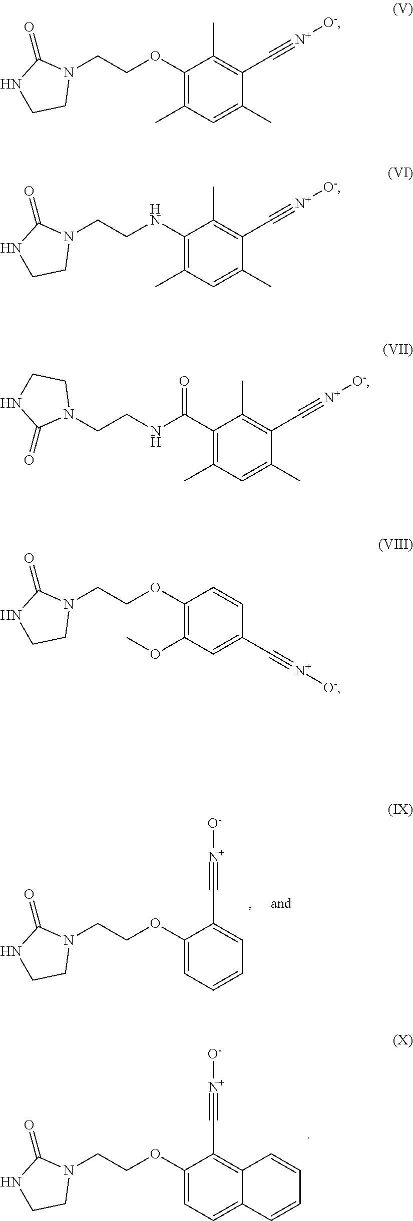

20. The rubber composition according to claim 16, wherein a content of 1,3-dipolar compound is between 0 and 50 molar equivalents per 100 moles of monomer units constituting the copolymer.

21. The rubber composition according to claim 16, wherein the filler comprises more than 70% by weight of silica.

22. The rubber composition according to claim 16, further comprising an agent for coupling the silica to the copolymer.

23. The rubber composition according to claim 22, wherein the coupling agent is an organosilane selected from the group consisting of organosilane polysulfides, polyorganosiloxanes, mercaptosilanes, acrylosilanes and methacrylosilanes.

24. The rubber composition according to claim 16, wherein the at least one radical polymerization initiator is selected from the group consisting of peroxides, azo compounds, redox systems and mixtures thereof.

25. The rubber composition according to claim 16, wherein the at least one radical polymerization initiator is an organic peroxide selected from the group consisting of dicumyl peroxide, aryl or diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane, n-butyl 4,4′ -di(tert-butylperoxy)valerate, OO-(t-butyl)O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3(4)-bis(tert-butylperoxyisopropyl)benzene and mixtures thereof.

26. The rubber composition according to claim 16, wherein a content of the at least one radical polymerization initiator is within a range extending from 1% to 10% by weight relative to a weight of the co-crosslinking agent.

27. The rubber composition according to claim 16, wherein the co-crosslinking agent comprises an acrylate derivative of formula (XI):
[X]ₚA (XI),
in which [X]p corresponds to a radical of formula (XII): 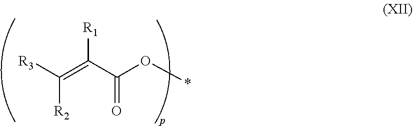
in which R₁, R₂ and R₃ independently represent a hydrogen atom or a C₁-C₈ hydrocarbon group selected from the group consisting of alkyl groups which are linear, branched or cyclic, alkylaryl groups, aryl groups and aralkyls, and which are optionally interrupted by one or more heteroatoms, it being possible for R₂ and R₃ together to form a non-aromatic ring,
(*) represents a point of attachment of the radical of formula (XII) to A,
A represents an atom belonging to the group consisting of alkaline earth metals or transition metals, a carbon atom or a C₁-C₃₀ hydrocarbon group, optionally interrupted and/or substituted by one or more heteroatoms, and
A comprises p free valencies, p having a value ranging from 2 to 6,
it being understood that X radicals are identical or different.

28. The rubber composition according to claim 27, wherein, in the acrylate derivative of formula (XI), R₁, R₂ and R₃ represent, independently of one another, a hydrogen atom, a methyl group or an ethyl group, A represents an atom belonging to the group consisting of alkaline earth metals and transition metals, a carbon atom or a C₁-C₁₃ hydrocarbon group, and A comprises p free valencies, p having a value ranging from 2 to 4, it being understood that X radicals are identical or different.

29. The rubber composition according to claim 16, wherein a content of co-crosslinking agent is within a range extending from 1 to 20 phr.

30. A rubber article comprising at least one rubber composition according to claim 16.

31. The rubber article according to claim 30, wherein the rubber article is selected from the group consisting of pneumatic tires, non-pneumatic tires, rubber caterpillar tracks and conveyor belts.
